(19) United States
(12) Patent Application Publication
(10) Pub. No.: US 2026/0318285 A1
(43) Pub. Date: Oct. 15, 2026

(54) BATTERY-POWERED WINDFARM ELEVATOR SYSTEM

(71) Applicant: SafeWorks, LLC, Tukwila, WA (US)

(72) Inventors: John Haigh, Tukwila, WA (US); Greg Crew, Tukwila, WA (US)

(73) Assignee: SafeWorks, LLC, Tukwila, WA (US)

(21) Appl. No.: 19/104,525

(22) PCT Filed: Aug. 21, 2023
(86) PCT No.: PCT/US2023/072576

§ 371 Date: Feb. 18, 2025

Related U.S. Application Data
(60) Provisional application No. 63/399,639, filed on Aug. 19, 2022.

(51) Int. Cl. F03D 80/50; E04G 3/28; E04G 3/30; E04G 5/00; H01M 10/48; H01M 10/615; H01M 10/627; H01M 10/633; H01M 50/251

(52) U.S. Cl. CPC F03D 80/50; E04G 3/305; H01M 10/486; H01M 10/615; H01M 10/627; H01M 10/633; H01M 50/251; E04G 2003/286; E04G 2005/008; F05B 2230/80; H01M 2220/10

(57) ABSTRACT

A lift system for a wind turbine includes an elevator car disposed inside the wind turbine. The elevator car includes a platform to support a worker, a sidewall extending from the platform, and a top portion coupled with the sidewall. The platform, sidewall, and top portion define a cabin. The lift system includes a traction hoist coupled with the top portion. The traction hoist is configured to move the elevator car within the wind turbine. The lift system includes a control panel operably coupled with the traction hoist. The control panel is configured to receive an input to control the traction hoist. The lift system includes a portable battery configured to power the traction hoist. The portable battery is configured to be removably coupled with the elevator car to electrically couple the portable battery with the traction hoist.

### CROSS-REFERENCE TO RELATED APPLICATION

This PCT Patent application claims priority to U.S. Provisional Application No. 63/399,639, filed Aug. 19, 2022, and is incorporated herein by reference in its entirety.

### BACKGROUND

Typical windfarms have a significant number of wind turbines (or simply “turbines”). Contemporary wind turbine towers are very tall, with many including internal elevator systems to enable maintenance workers to reach and to service the turbine generating equipment located in the nacelle without climbing a ladder. Such elevator systems installed in the turbine tower are used only by service personnel and are otherwise not used. Moreover, the turbines tend to be located in areas that are not readily accessible and are kept secure so that the interior to the towers are not accessed by unauthorized persons.

### SUMMARY

One embodiment is directed to a lift system for a wind turbine. The lift system includes an elevator car disposed inside the wind turbine. The elevator car includes a platform to support a worker, a sidewall extending from the platform, and a top portion coupled with the sidewall. The platform, the sidewall, and the top portion define a cabin. The lift system includes a traction hoist coupled with the elevator car. The traction hoist is configured to move the elevator car within the wind turbine. The lift system includes a control panel operably coupled with the traction hoist. The control panel is configured to receive an input to control the traction hoist. a portable battery configured to power the traction hoist, the portable battery configured to be coupled with the elevator car and electrically coupled with the traction hoist.

One embodiment is directed to a portable battery for a lift system of a wind turbine. The portable battery includes a body comprising a length, a width, and a height. The width is less than the length and the height. The body is configured to be removably coupled with an elevator car of the lift system. The portable battery includes a battery power terminal disposed on the body. The battery power terminal is configured to align with a lift power terminal of the lift system to electrically couple the portable battery with a traction hoist of the lift system. The portable battery includes a retention element disposed on the body. The retention element is configured to engage with a retention feature of the elevator car to removably couple the portable battery with the elevator car.

One embodiment is directed to a method to operate a lift system of a wind turbine with a portable battery. The method includes removably coupling the portable battery with an elevator car. The elevator car is disposed in the wind turbine. The method includes aligning a battery power terminal with a lift power terminal to electrically couple the portable battery with a traction hoist of the lift system. The method includes providing an input to the traction hoist via a control panel to cause the elevator car to move within the wind turbine based on power provided by the portable battery. The method includes removing the portable battery from the wind turbine.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The foregoing summary, as well as the following detailed description of illustrative embodiments, is better understood when read in conjunction with the appended drawings. The accompanying drawings are not intended to be drawn to scale. Like reference numbers and designations in the various drawings indicate like elements. For purposes of clarity, not every component may be labeled in every drawing. The drawings illustrate exemplary embodiments; however, the present disclosure is not limited to the specific methods and instrumentalities disclosed. In the drawings:

FIG. 1 depicts a windfarm having a number of wind turbines, according to an example embodiment;

FIG. 2 is an enlarged view of a wind turbine having a lift system, according to an example embodiment;

FIG. 3 is a schematic diagram of a hoist for use in the elevator car of FIG. 2;

FIGS. 4A and 4B are schematic diagrams for the switching in the control system of the hoist illustrated in FIG. 3, according to an example embodiment;

FIGS. 5A and 5B are flow diagrams of methods to operate the hoist illustrated in FIG. 3, according to an example embodiment;

FIG. 6 is a flow diagram of a method to reuse a portable battery in a windfarm, according to an example embodiment;

FIGS. 7A and 7B depict mechanical aspects of a hoist, according to an example embodiment;

FIG. 8 is an enlarged view of a wind turbine having a lift system, according to an example embodiment;

FIG. 9 is a perspective view of a portable battery of the lift system of FIG. 8, according to an example embodiment; and

FIG. 10 is a flow diagram of a method to operate a lift system of a wind turbine with a portable battery, according to an example embodiment.

### DETAILED DESCRIPTION

The embodiments disclosed herein are not limited in application to the details of construction and the arrangement of components set forth in the following description or illustrated in the drawings. The disclosure is capable of other embodiments and of being practiced or being carried out in various ways. In addition, the phraseology and terminology used herein is for the purpose of description and should not be regarded as limiting.

Aspects of the disclosure will now be described in detail with reference to the drawings, wherein like reference numbers refer to like elements throughout, unless specified otherwise. Certain terminology is used in the following description for convenience only and is not limiting. The term “plurality”, as used herein, means more than one. The terms “a portion” and “at least a portion” of a structure include the entirety of the structure. Certain features of the disclosure, which are described herein in the context of separate embodiments, may also be provided in combination in a single embodiment. Conversely, various features of the disclosure that are described in the context of a single embodiment may also be provided separately or in any subcombination.

As noted above, windfarms have a significant need for elevator systems. The height of wind turbine towers set up at windfarms has increased significantly over time. Contemporary wind turbine towers may exceed 300 feet in height and that is expected to continue to increase. The generator part of the turbine generally is located at the top of the tower in a section called the nacelle. The nacelle houses a gear box, generator, and other components used in the generation of electricity. These components require regular maintenance to keep the wind turbines operational. Hence, elevators have become increasingly common to carry both maintenance workers and equipment from the ground to the top of the tower and points in between.

Typically, the elevators disposed within the wind towers will use a hoist to provide the lift to the elevator along with the load of maintenance workers and material. Such hoists may use a suspended path medium. A suspended path medium typically is a wire rope.

The elevator platform can be used to support a load, such as one or more persons according to one example. Personnel hoists, particularly the type installed within wind turbine towers, may operate via a traction sheave principle to pull the platform along the suspended rope.

The present disclosure is directed to systems and methods for powering a lift system of a wind turbine via a portable battery. The battery can be manually transported between and provide power to elevators installed in various wind turbines such that each elevator does not require a permanent, designated power supply. The battery is designed to be disposed in the cabin of an elevator car in the wind turbine and be removably coupled with the elevator car for easy install and disconnection. The battery may have a thin form factor to reduce the cabin space occupied by the battery, to provide as much space in the cabin for workers and equipment. The portable battery eliminates the need for large power supply lines to extend the height of the wind turbine, and eliminates the need for each elevator to have a designated, permanent power supply.

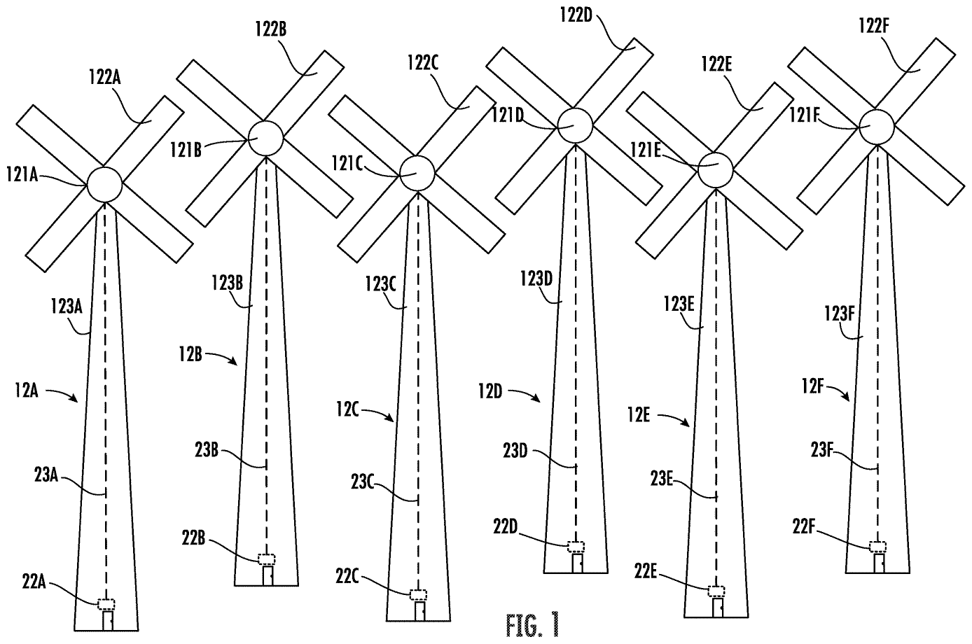

Referring to FIG. 1, a depiction of a windfarm is provided in schematic form. Windfarms are typically comprised of a number of wind turbines, e.g., 12a-12f. Each wind turbine comprises a tubular tower e.g., 123a-123f, that are typically formed from steel, concrete, or a combination of the two. At the top of the tubular tower, e.g., 123a-123f, a set of turbine blades, e.g., 122a-122f are coupled to a hub, e.g., 121a-121f. The Hubs are then coupled to the nacelle, not shown.

Each wind turbine tower comprises an access door, e.g., doors 124a-124f, through which a maintenance worker can access the interior of the tubular tower. An elevator car, e.g., 22a-22f, is disposed. The elevator cars are suspended from a wire rope e.g., 23a-23f.

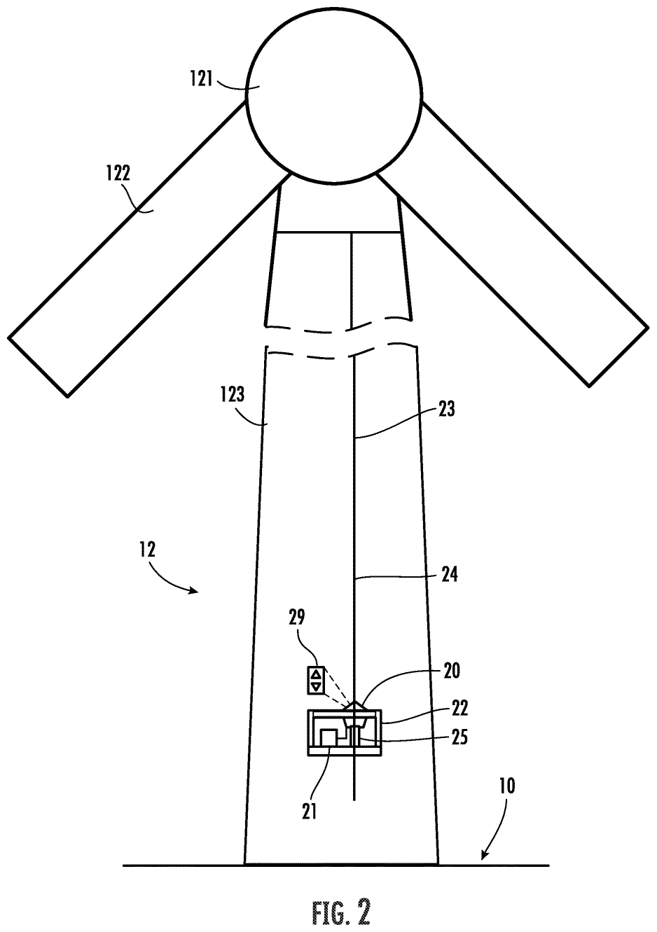

Referring to FIG. 2, a hoist 20, (hereinafter also referred to as hoist 20) is configured to lift and lower the elevator platform. Hoist 20 comprises a traction type hoist. As shown in the illustrated embodiment, the hoist 20 may be deployed at a location 10, such as a wind farm comprising wind turbine tower 12. The hoist 20 may attach to an elevator car 22 and at least one cable 24 (hereinafter the cable 24). The hoist 20 is typically attached by stirrup bar 25 to a corresponding stirrup on the elevator car. The hoist 20 is attached to the cable by feeding the cable through a wire rope insertion point in the top of the hoist.

The hoist 20 may further include a control mechanism, shown as control panel 29, that is configured to receive an input from a user and control the hoist 20 based on the input. In some embodiments, the control panel 29 may be a part of or coupled with the elevator car 22 (e.g., built into or electrically coupled with the hoist 20) and accessible to a person standing on the platform to enable the person to control the hoist 20 to control movement of the elevator car 22. The control panel 29 is configured to send a signal to the hoist 20 to move the elevator car 22 in a direction that corresponds to the input from the user. For example, the control panel 29 may include a plurality of buttons, including a first button configured to send a signal to a hoist motor to raise the load, a second button configured to send a signal to the hoist motor to lower the load, and a third button to configured to send a signal to the motor to stop movement of the load. The control panel 29 may be wired to the hoist 20. The hoist 20 may further include an overspeed safety mechanism 31, which is configured to slow or stop the elevator car 22 from lowering, in the event that the platform 22 reaches a predetermined descent speed.

A portable battery 21 is coupled to the hoist 20 during operation of the elevator car 22. Battery 21 provides a source of direct current (DC) power to hoist 20. The battery 21 is may be lithium based such as lithium ion or lithium phosphate, or other chemistry. The battery 21 is typically placed on and/or attached to the platform of elevator car 22 and is coupled to the hoist 20 by way of a power supply cable. The battery 21 may be removed from the elevator car 22 and recharged without requiring the hoist 20 to be disconnected from the platform and/or cable 24.

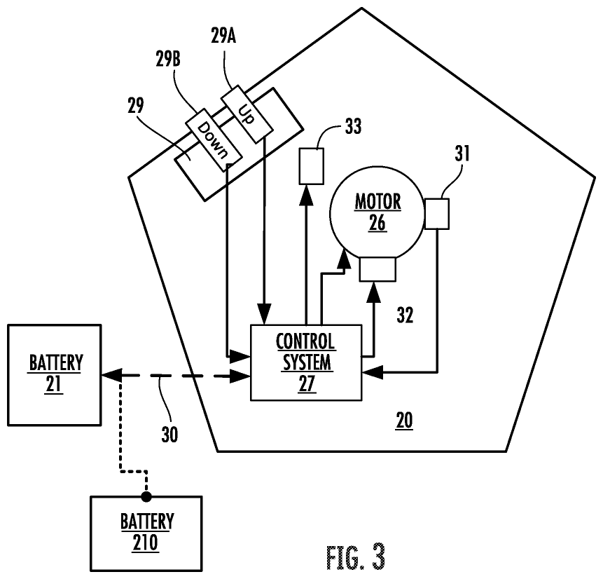

Referring to FIG. 3, a control system 27 is operably coupled with the hoist 20. The control system 27 is configured to receive a DC power input from battery 21 and to control the feed of that power to motor 26. Motor 26 is a direct current motor configured to receive power as an input and convert the power into movement. The motor 26 is configured to convert the power input into rotational movement of a sheave (not shown). The motor drive 27 may be configured to control characteristics of the rotational movement of a drive shaft 28 not shown. The characteristics of the motor may include, but are not limited to, speed, torque, direction, and any combination thereof.

The hoist 20 may be configured such that the battery 21 is positioned close to the hoist 20. The battery 21 is preferably connected to hoist 20 by way of cable 30. The battery connection makes the hoist 20 useful in situations such as wind turbine towers where the extended height of the tower makes it difficult to us power cables from a source external to the elevator car 22. In such a case, the wires would need to extend the length of the distance from the base of the tower to the top of the tower. The power cables would be susceptible to swinging and creating a safety hazard for maintenance workers and other personnel in the wind turbine tower, or otherwise susceptible to entanglement in or damage from contact with fixed elements within the tower.

Preferably, the battery 21 is removable or portable. In some embodiments, the hoist 20 may have a secondary battery 210 that provides power to the hoist 20 to move the hoist to a location, e.g., along the length of the cable 30 to access power to recharge either one or both of battery 21 and 210. The battery 21 may be installed on the platform on elevator car 22, for example on rails on a bottom side of the platform of elevator car 22, or on vertical rails of the elevator car 22. The battery 21 may be installed in one location on the platform 22, or in multiple locations. Battery 210 may likewise be attached to the platform on elevator car 22 or may be attached directly to hoist 20. In this manner, as explained more fully herein, the main battery 21 can be moved from hoist 20 to hoist 20, in a multi-hoist installation, such as a windfarm, and the hoist 20 can nevertheless be moved using the auxiliary battery 210.

The current is supplied from the battery 21 to the control system 27. The control system 27 signals the motor 26 to control the output, for example the speed, direction, and torque. The motor 26 upon receiving a corresponding signal from the control system 27, may apply traction or brakes to the motor 26.

FIG. 3 further illustrates that the control system 27 receives inputs from control panel 29, which may include inputs from up signal 29A or down signal 29B. In the case of an up signal 29A and down signal 29B, that input may be in the form of an electro-mechanical button, a touchscreen, or the like.

The control system also receives input from a sensor 31. Sensor 31 is preferably a hall effect sensor. The hall effect sensor measures the speed of rotation of the motor 26. That information is supplied to control system 27. The feedback to the control system 27 allows the control system 27 to maintain the rated speed of the motor 26 as the battery 21 loses charge.

The control system 27, provides power to motor 26. That power control is based on inputs from the up and down signals 29A and 29B as well as hall sensor 31. The power is controlled to maintain the hoist 20 at a set speed in both the up and down directions.

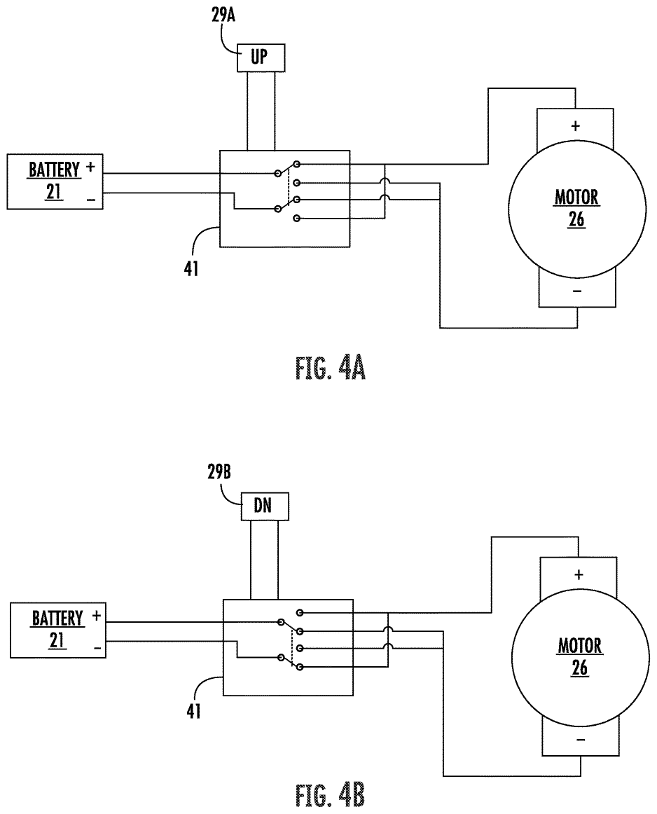

As shown in the schematic depiction of FIGS. 4A and 4B, when the control system 27 receives an up signal 29A, power from the battery positive is provided on a first power input terminal and battery negative is provided on a second power input terminal. During descent, when a user presses the down button generating a down signal 29B, the control system 27 flips the polarity of the power to the motor 26 and causes the motor rotation to reverse. The motor 26 descent is controlled to generate power from the weight of the payload during a controlled descent that is maintained at constant down speed that does not exceed a predefined speed. To the extent that the speed exceeds the controlled descent speed, the control system 27 may employ a resistor 33 and/or a brake 32.

The table below provides specifications and features of the hoist 20, according to example embodiments.

TABLE 1

| Feature | Function | Benefit |
|---|---|---|
| Operating | Proven reliable performance | Reduces service calls |
| Range: | Tested in 1 hour continuous | Extends electric component life |
| 40 VDC- | run tests | Eliminates power-induced down time |
| 48 VDC | | Saves time and money |
| Load-sensitive | Applies only the traction | Greater tolerance of wire rope |
| Traction | needed to lift load, not full | condition |
| | 1,000 lb (454 kg) lifting force | Extends wire rope life by minimizing |
| | on rope | wear and tear on rope |
| | Virtually eliminates the risk of | Prevents costly wire rope jams |
| | wire rope jams | Reduces the need for rescues |
| Controlled | Allows downward travel at a | Eliminates need for rescue |
| Descent | controlled rate of speed in the | Allows self-rescue of workers and |
| | event of power loss | platforms |
| Built-in | Stops hoist in overspeed | Ensures greater operator safety |
| Overspeed Brake | condition | Improved reliability |
| | Can't be left behind in shop, | |
| | bypassed, or dismantled | |
| Battery Powered | Provides up to 3 hours of run | Allows for operation in situations |
| | time | where on-site power is not available or |
| | Rechargeable | feasible |
| Battery | Battery will recharge while | Extends operational time |
| Regeneration | operating in the down direction | |
| (in down | | |
| direction) | | |
| Overspeed Trip | DOWN button lights up red | Gives the operator greater control and |
| Indicator | when overspeed has been | understanding |
| (Incorporated | tripped and DOWN circuit has | |
| into DOWN | been interrupted | |
| Button) | | |
| Remote Ready | Built-in pendant port accepts | No need to drill and wire remote into |
| | plug-in remote control. | hoist |
| | | Leaves hoist mounted controls |
| | | operable |
| Overload Kit | Allows overload to be shop-set | Reduces rigging material and labor |
| | to 125% of rated load | |

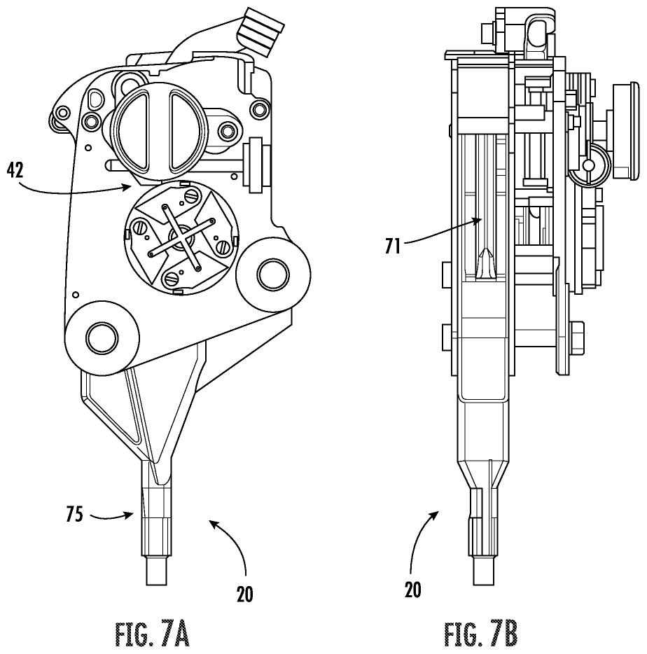

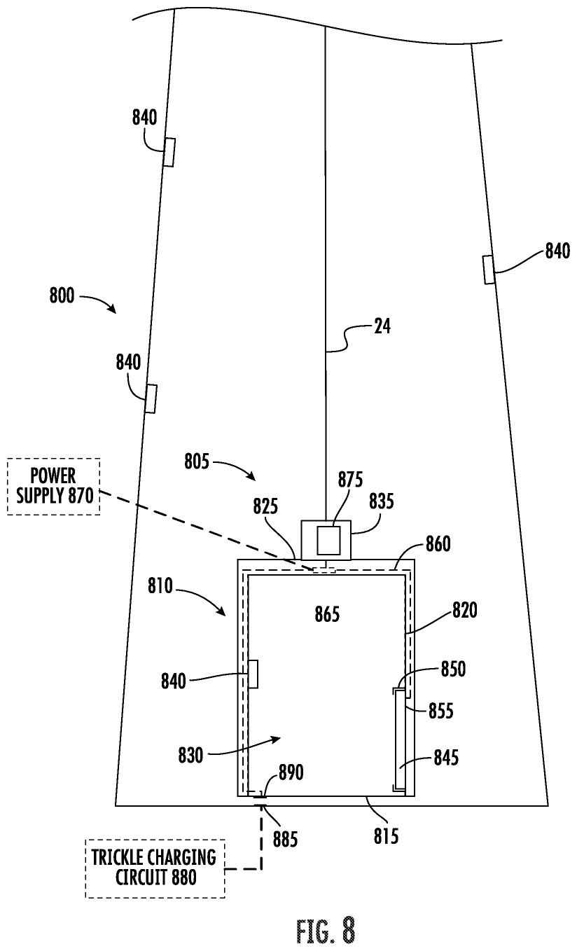

As noted above, hoist 20 may be a traction hoist. FIGS. 7A and 7B provide an example embodiment of mechanical aspects of a traction hoist 20 that may be used to carry out aspects of the systems described herein. FIG. 7A is a front view of some of the interior mechanical components of hoist 20. FIG. 7B is a side view of the mechanical features of hoist 20 of 7A. Element 71 is a traction sheave that is rotated by motor 26 to raise or lower the hoist 20 relative to rope 23. Element 59 is a flywheel that works in conjunction with the overspeed system to monitor the speed of descent of the hoist. Element 42 is an overspeed trigger that triggers the overspeed protection when activated. Element 75 is a rope guide for egress of the rope through the hoist 20 in the up direction and ingress in the down direction.

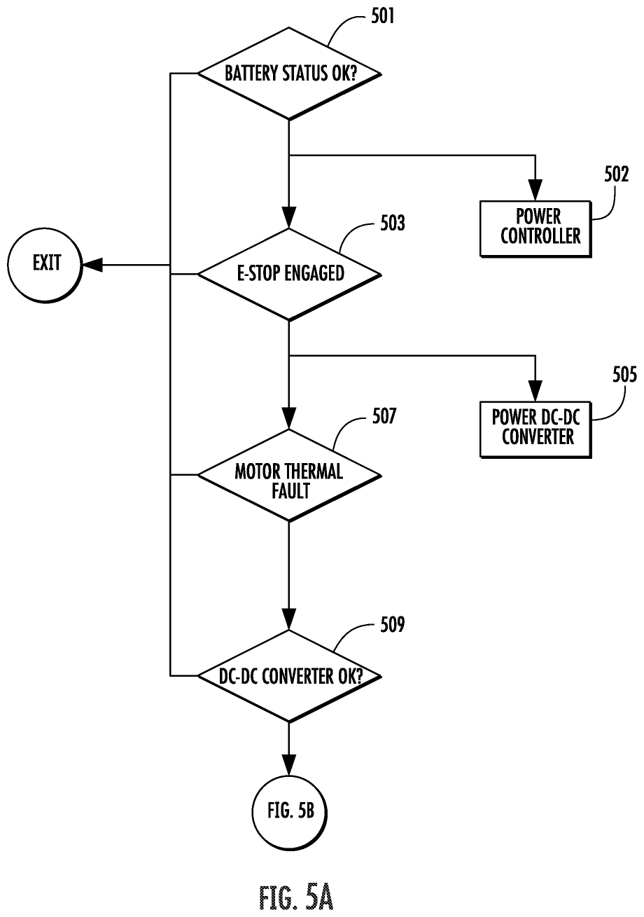

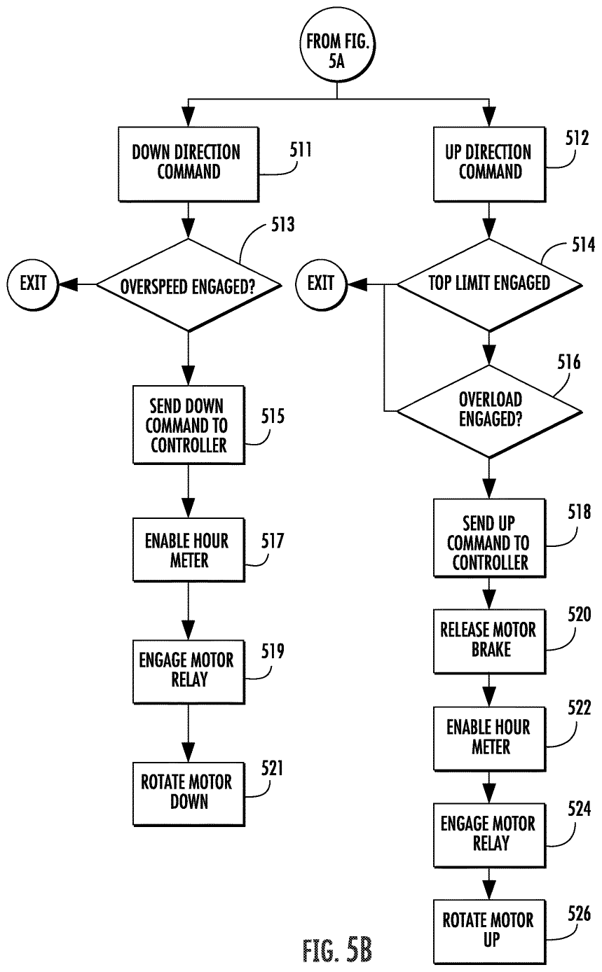

FIGS. 5A and 5B provides an example flow chart that describes the motor operation. As shown in FIG. 5A, when the hoist 20 first starts up, at step 501, a battery status check is performed. If the battery 21 has sufficient power, etc., the control board including the controller is powered on at step 502. Next at step 503, if the emergency stop is engaged, the system stops. Although the flow chart shows the test of the emergency stop as operating sequentially, that is for illustration. Any time that the emergency stop button is engaged, the hoist 20 will stop.

Otherwise, the DC-DC converter is power to adjust to battery voltage to a usable voltage for the hoist at step 505. Thereafter a couple of general status checks are performed. At step 507, the motor thermal fault protection is checked. A thermal fault could occur, for example, if the motor is overloaded. The DC-DC converter is checked at step 509 for proper operation.

As shown in FIG. 5B, at steps 511 and 512, the hoist 20 detects whether the operator has selected the up or down direction. In step, 513 after the operator selects the down direction, the hoist 20 determines whether the overspeed is engaged at step 515, if so, the hoist 20 will stop. If the overspeed is not engaged, the hoist 20 will send the down command to the controller at step 515 to cause the hoist 20 to move the hoist 20 down at a predetermined rate. The hour meter will also engage at step 517 to track the amount of time that the hoist 20 is in use and the motor relay will engage at step 519 to ensure that the proper polarity of the voltage is applied to the motor. The motor will then rotate in the down direction at step 521.

On the other hand, if an operator selected the up direction button, an up command is received at step 512. In that case, the system, will automatically stop if the top limit switch is engaged at step 514. The top limit switch is on the top of the elevator car 22 or another structure that prevents the hoist 20 from continuing up when the top of the travel limit has been reached. The system also checks whether the overload switch has engaged. If the overload switch is engaged, that is an indication that the hoist 20 is overloaded and the hoist 20 will only be able to operate in the down direction until the overload weight is removed.

According to an aspect of the invention, the structures describe above provide for advantages in the utilization of expensive battery systems and promote safety of wind farm turbines. Wind turbine service personnel can be provided with a battery that can be carried between wind turbine towers. Consequently, all of the wind turbine towers would not require expensive battery systems. Instead, each wind turbine tower would be equipped with a battery-ready elevator equipped with a hoist for lifting personnel and equipment within the wind turbine tower. To that end, unauthorized persons who gain access to a wind turbine tower would have limited access to the top of the tower because absent a battery, the elevator would be non-operational.

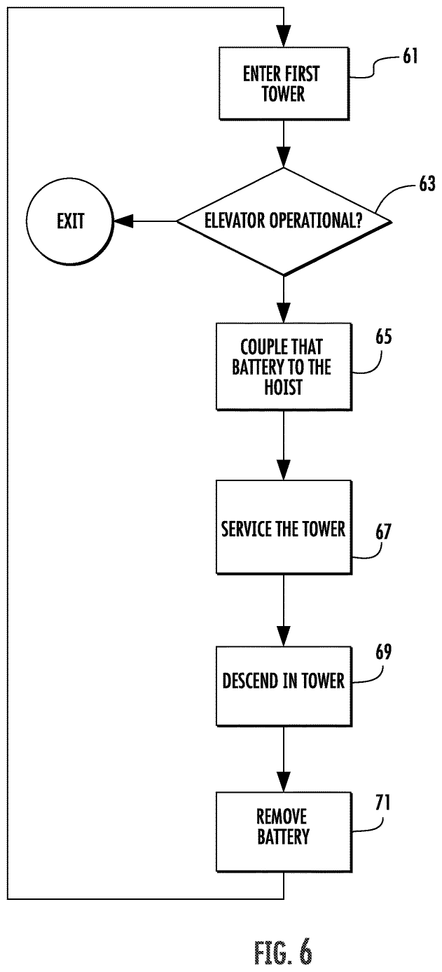

FIG. 6 describes an example method to reuse a battery in a wind turbine farm. A service person arrives at the wind farm to service at least one of several wind turbines. For example, towers 12a and 12e may require service. The service of individual turbines may be performed during the same visit or spread over several visits.

A service person, then enters the first tower carrying a battery 21 at step 61. The service person may determine whether the elevator hoist 20 is operational at step 63. A particular hoist 20 in a tower 12 may have a small battery (e.g., insufficient to operate the hoist in a normal operation but able to power a hoist to adjust the height of the elevator etc.) built-in or coupled to the hoist 20 and situated in the elevator. The small battery would enable the service person (referred to as “hoist operator” in the alternative) to adjust the elevator as needed.

The larger battery 21 can then be secured to the elevator and coupled to the hoist 20 to supply sufficient power to power the hoist to lift the service person(s) along with equipment at step 65. The service person can then use the elevator to service the wind turbine at step 67 To that end, the service person may operate the elevator to reach the nacelle, for example, to service the turbine. The service person cold also stop at intermediate work platforms along the way, allow the service person to exit the elevator and service the tower or provide maintenance, etc. After the task is complete, the service person can take the elevator to the exit level. Once there, the service person can detach the battery 21 and move the elevator to a parked location using the smaller battery. The larger battery 21 may also be operable to charge the smaller battery during operation. Moreover, the smaller battery may be designed to first receive a charge from the hoist as the hoist descends. It may be that the larger battery only receives return charge energy from the hoist after the smaller battery is fully charged.

Afterward completing the maintenance, the service person may descend on the elevator at step 69. The service person then removes the battery 21, which renders the elevator inoperable at step 71. The service person can exit the tower, e.g., tower 12a and move to tower 12e to provide services or maintenance to the second tower. In the meantime, it may be that as the service person moves from tower to tower, the larger battery is depleted. The battery 12 may be returned to, for example, a service vehicle to be recharged and a second battery 12 used to continue servicing the wind turbine towers on the wind farm.

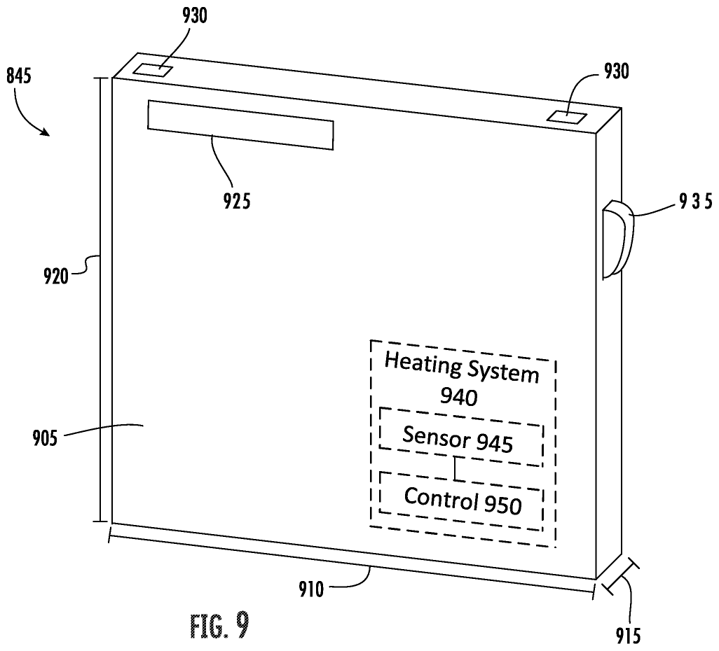

FIG. 8 depicts a portion of wind turbine 800. The wind turbine 800 may be similar to or the same as any of wind turbines 12a-12f. The wind turbine 800 includes at least one lift system 805. The lift system 805 allows workers to reach various locations within the wind turbine to provide service and maintenance. The lift system 805 includes at least one elevator car 810. The elevator car 810 may be similar to or the same as elevator car 22. Elevator car 810 is disposed inside the wind turbine 800. The elevator car 810 is configured to move within the wind turbine 800 (e.g., vertically). The elevator car 810 includes at least one platform 815. The platform 815 may be configured to support a load (e.g., a worker and/or equipment). The elevator car 810 includes at least one sidewall 820. The sidewall 820 may extend from the platform 815. The elevator car 810 includes at least one top portion 825. The top portion 825 may be coupled with the sidewall 820. The platform 815, the sidewall 820, and the top portion 825 may define a cabin 830 of the elevator car 810. The worker and/or equipment can be disposed in the cabin 830 when the elevator car 810 moves within the wind turbine 800.

The lift system 805 includes at least one hoist, shown as traction hoist 835. The traction hoist 835 may be similar to or the same as hoist 20. The traction hoist 835 may be coupled with the top portion 825 of the elevator car 810. The traction hoist 835 is configured to move the elevator car 810 within the wind turbine 800. The traction hoist 835 may be any type of hoist or mechanism configured to lift and lower the elevator car 810 within the wind turbine 800.

In some embodiments, the traction hoist 835 may be configured to provide a controlled descent. For example, the traction hoist 835 may be capable of a power descent and an unpowered descent. During the unpowered descent, the traction hoist 835 may be configured to control the speed of the descent. For example, the traction hoist 835 may be configured to prevent the elevator car 810 from descending at a speed greater than a predetermined speed threshold.

The lift system 805 includes at least one control mechanism, shown as control panel 840. The control panel 840 may be similar to or the same as control panel 29. The control panel 840 may be operably coupled with the traction hoist 835. The control panel 840 may be configured to receive an input from a user to control the traction hoist 835. For example, the control panel 840 may include at least one input mechanism (e.g., a button, touch screen, switch, etc.) to receive the input. The control panel 840 may generate a signal based on the input to move the elevator car 810 according to the input received.

The lift system 805 may include a plurality of control panels 840. For example, a first control panel 840 may be disposed in the cabin 830 of the elevator car 810 and a second control panel 840 may be disposed at an elevated location within the wind turbine 800. For example, the wind turbine 800 may have various work sites inside the wind turbine 800. The second control panel 840 may be disposed at a work site remote from the elevator car 810 such that a worker at the work site can send a signal to call the elevator car 810 when the worker needs to move to a different location. For example, the remote control panel 840 can facilitate a call/send functionality such that a worker can call for an empty elevator car 810 or send an empty elevator car 810 without being in the elevator car 810. A plurality of control panels 840 may be disposed in the wind turbine 800. A call/send signal from a remote control panel 840 may be overridden by an input received via the permanent control panel 840 disposed in the elevator car 810.

The lift system 805 includes at least one battery 845. The battery 845 may be similar to or the same as battery 21. The battery 845 is portable. For example, the battery 845 can be selectively disposed in and removed from the cabin 830 and selectively coupled with and decoupled from the elevator car 810. The portable battery 845 can be moved between and provide power to various lift systems 805. The battery 845 may be rechargeable. The battery 845 is configured to provide power to the traction hoist 835. The battery 845 may be disposed in the cabin 830 of the elevator car 810. With the battery 845 disposed in the cabin 830, the lift system 805 may not include a power supply cable that extends between the elevator car 810 or traction hoist 835 and a permanent power supply of the wind turbine 800.

The battery 845 may provide DC power to the traction hoist 835. With the DC power, the traction hoist 835 may be configured to control an amount of DC power consumed from the battery 845 to gradually increase a speed of the elevator car 810. For example, the DC power allows the traction hoist 845 to ramp up or ramp down the power consumed. Contrastingly, traditional AC power systems switch between off and full power without any controllability in between, creating a jolt or jerk when initiating movement of the elevator car 810. Instead, the DC power from the battery 845 facilitates a smooth start and stop of the movement of the elevator car 810.

In some embodiments, the lift system 805 may include a plurality of batteries 845. The power from the plurality of batteries 845 may be combined to provide enough power to facilitate the desired movement of the elevator car 810. The list system 805 may include a plurality of batteries 845 to limit the weight of a single battery 845. For example, since the battery 845 is portable, the weight of the battery 845 may be limited to ensure easy transport of the battery 845. For example, the weight of the battery 845 may be less than fifty pounds. In some embodiments, the weight of the battery 845 may be less than thirty pounds.

The battery 845 may be configured to couple with at least one of the platform 815 or the sidewall 820 of the elevator car 810 to electrically couple the battery 845 with the traction hoist 835. In some embodiments, the sidewall 820 may include at least one retention feature 850. The retention feature 850 may be disposed on or coupled with the sidewall 820. The retention feature 850 may be configured to secure the battery 845 at a position within the cabin 830 of the elevator car 810 to facilitate and maintain an electrical connection between the battery 845 and the traction hoist 835. The retention feature 850 can be any type of retention feature configured to secure the battery 845. For example, the retention feature 850 may be a pocket to receive the battery 845, may be a snap feature for the battery 845 to snap into, or a rail or track for the battery 845 to slide into or along. In some embodiments, the platform 815 may include the retention feature 850.

The lift system 805 may include a lift power terminal 855. The lift power terminal 855 may be configured to interface with a power terminal of the battery 845 to electrically couple the battery 845 with the traction hoist 835. The lift power terminal 855 may be disposed on the sidewall 820 of the elevator car 810. The lift power terminal 855 may be electrically coupled with the traction hoist 835. For example, an electrical conduit 860 may extend between the lift power terminal 855 and the traction hoist 835 to electrically couple the lift power terminal 855 with the traction hoist 835.

In some embodiments, the traction hoist 835 may be configured to provide regenerative braking. For example, during a descent of the elevator car 810, the traction hoist 835 may be configured to recapture power and provide the power to the battery 845 to recharge the battery 845. In some embodiments, the traction hoist 835 may be configured to recapture about 30% of the power consumed from the battery 845. For example, when powered, a motor of the traction hoist 835 may rotate in a first direction. During an unpowered descent, the motor may rotate in a second direction opposite the first direction. The rotation in the second direction may be caused by the weight of the elevator car and any load therein (e.g., the traction hoist 835, a worker, equipment, etc.).

In some embodiments, the lift system 805 may include at least one elevator control system 865. The elevator control system 865 may be configured to receive signals and generate outputs to operate the elevator car 810. For example, the elevator control system 865 may be configured to receive signals from a control panel 840, either a control panel 840 disposed in the elevator car 810 or a control panel 840 disposed remote from the elevator car 810. The elevator control system 865 may be configured to operably couple the traction hoist 835 with the control panel(s) 840 and actuate the traction hoist 835 based on the input signals received from the control panel(s) 840. The elevator control system 865 may be configured to operably couple the battery 845 with the traction hoist 835. For example, the elevator control system 865 may be electrically coupled with the battery 845 via an electrical conduit and electrically coupled with the traction hoist 835 via another electrical conduit. The elevator control system 865 may receive the power from the battery 845 and provide a desired amount of the power to the traction hoist 835 to power the traction hoist 835. The elevator control system 865 may be installed in or coupled with the elevator car 810.

The elevator control system 865 may electrically couple with the control panel 840 disposed in the elevator car 810 via an electrical conduit (e.g., a wire) of the elevator car 810. The elevator control system 865 may be configured to wirelessly receive a signal from a remote control panel 840 to control the traction hoist 835 with the control panel 840 disposed at a remote location relative to the elevator car 810. As such, an operator may be able to control the movement of the elevator car 810 without being in the cabin 830 of the elevator car 810. Being able to control the elevator car 810 without being disposed in the cabin 830 may allow the elevator car 810 to be stored at a location that is not accessible to people (e.g., stored off the ground or at the top of the wind turbine 800), which may be beneficial for off-shore wind turbines 800, for example. Being able to control the elevator car 810 without being disposed in the cabin 830 may also allow a worker to call or send the elevator car 810 to a desired location without being disposed in the elevator car 810. Further, since no power supply conduit is needed to provide power due to the portable battery 845, the elevator control system 865 allows for there to be no hard communication lines between the ground and an elevated elevator car 810.

In some embodiments, the lift system 805 includes an auxiliary power supply, shown as power supply 870. The power supply 870 may be configured to power the elevator control system 865. The power supply 870 may be separate from the battery 845. For example, the power supply 870 may provide power to the elevator control system 865 when the battery 845 is not disposed in the cabin 830 of the elevator car 810.

In some embodiments, the lift system 805 may include a supplemental power supply 875. The supplemental power supply 875 may be configured to provide power to the traction hoist 835. The supplemental power supply 875 may provide less power than the battery 845. For example, the supplemental power supply 875 may provide enough power to the traction hoist 835 for only a single trip of the elevator car 810. The supplemental power supply 875 may be any type of power source. In some embodiments, the supplemental power supply 875 may be a lead acid battery. The supplemental power supply 875 may be a part of or electrically coupled with the traction hoist 835 via a control box. The supplemental power supply 875 may be permanent such that the supplemental power supply 875 remains with the designated elevator car 810. The supplemental power supply 875 may provide the ability for the elevator car 810 to be stored at a location such that the elevator may need to move to a different location within the wind turbine 800 before the battery 845 is disposed couple with the traction hoist 835 (e.g., an offshore wind turbine). For example, the supplemental power supply 875 may facilitate a single trip of the elevator car 810 without the battery 845 installed in the cabin 830. In some embodiments, the regenerative braking of the traction hoist 835 may be configured to recharge the supplemental power supply 875.

In some embodiments, the lift system may include a trickle charging circuit 880. The trickle charging circuit 880 may be configured to provide a low voltage trickle charge to the supplemental power supply 875 to charge the supplemental power supply 875 with the elevator car 810 in a stored position. The trickle charging circuit 880 may be configured to slowly and continuously charge the supplemental power supply 875 at a slow and controlled rate to ensure the supplemental power supply 875 retains enough power to facilitate a single trip of the elevator car 810. The trickle charging circuit 880 may be configured to provide trickle charging when the elevator car 810 is in a stored position. For example, the trickle charging circuit 880 may include a charging port 885 that is configured to align with and couple with a power port 890 of the elevator car 810 with the elevator car 810 in the stored position (e.g., at the base of the wind turbine 800). The power port 890 may automatically couple with the charging port 885 with the elevator car 810 in the stored position and automatically initiate the trickle charging of the supplemental power supply 875. In some embodiments, the power port 890 may be on a bottom of the platform 815 of the elevator car 810 to couple with the charging port 885 that is disposed at the bottom of the wind turbine 800. In some embodiments, the charging port 885 may be a hard docking station and the power port 890 is configured to automatically plug into the hard docking station when the elevator car 810 is in the stored position. At least one of the trickle charging circuit 880 or the supplemental power supply 875 may a heating system to maintain a temperature of the supplemental power supply 875. This heating system may be similar to the heating system of the battery 845 described in more detail herein.

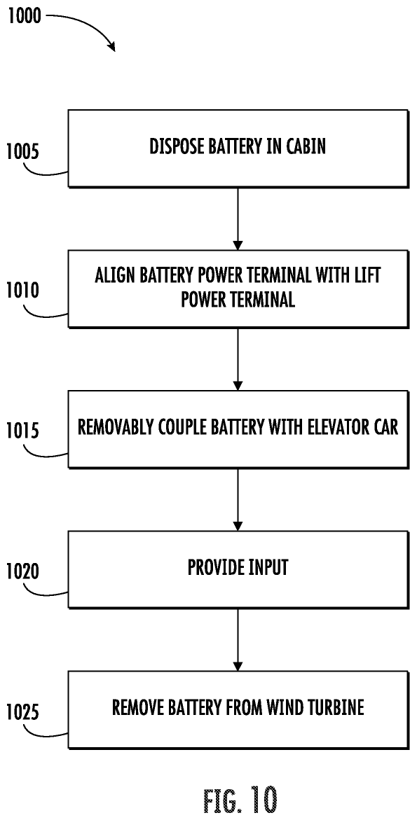

FIG. 9 depicts an example battery 845, according to an example embodiment. The battery 845 may have a body 905. The body 905 may have a form factor designed to reduce the space the battery 845 occupies in the cabin 830 when installed in the elevator car 810. For example, the body may have a length 910, a width 915, and a height 920. The width 915 may be less than both the length 910 and the height 920. When installed in the elevator car 810, the battery 845 may extend into the cabin 830 away from the sidewall 820 a distance equal to the width of the battery 845. As such, the longer dimensions of the battery 845 may extend parallel with the sidewall 820 and the shortest dimension of the battery 845 may extend perpendicular to the sidewall 820 to minimize the space in the cabin 830 occupied by the battery 845, leaving more room for workers and equipment.

The battery 845 may include at least one power terminal, shown as battery power terminal 925. The battery power terminal 925 may be configured to align with and electrically couple with the lift power terminal 855 to electrically couple the battery 845 with the traction hoist 835. The battery power terminal 925 may be disposed or exposed on any side or surface of the body 905 of the battery 845. For example, the battery power terminal 925 may be disposed on the top, bottom, side, front, or rear of the battery 845. The location of the battery power terminal 925 may be based on the location of the lift power terminal 855 such that the battery power terminal 925 and the lift power terminal 855 align with the battery 845 installed in the elevator car 810. In some embodiments, at least one of the battery power terminal 925 or the lift power terminal 855 may be flexible to help align the terminals 925, 855. For example, at least one of the battery power terminal 925 or the lift power terminal 855 may be coupled with a flexible wire such that the at least one of the battery power terminal 925 or the lift power terminal 855 can be adjusted and oriented to connect with the other.

The battery 845 may include at least one retention element 930. The retention element 930 may be disposed on the body 905. The retention element 930 may be configured to engage with the retention feature 850 of the elevator car 810 to removably couple the battery 845 with the elevator car 810. For example, the retention element 930 may be configured to facilitate quick connection and disconnection from the elevator car 810. For example, the retention element 930 may correspond with the retention feature 850 of the elevator car 810 such that the battery 845 may snap or slide into place to couple with the sidewall 820 of the elevator car 810. For example, the retention element 930 may be a hook, a snap, a rail or track, among other elements to interface or engage with the retention feature 850 of the elevator car 810. In some embodiments, the battery 845 may be configured to couple with the sidewall 820 of the elevator car 810 via engagement between the retention feature 850 and the retention element 930.

In some embodiments, the battery 845 may include at least one alignment feature 935. The alignment feature 935 may be configured to facilitate proper placement and orientation of the battery 845 to align the battery power terminal 925 with the lift power terminal 855. For example, the alignment feature 935 may be configured to prevent installation of the battery 845 unless the battery 845 is oriented and positioned in the proper way. The alignment feature 935 may be, for example, a projection that extends from the body 905 or a recess that extends into the body 905. The battery 845 may not be able to be coupled with the elevator car 810 until the alignment feature 935 is disposed at the proper location such that the retention element 930 of the battery 845 can engage the retention feature 850 of the elevator car 810. In some embodiments, at least one of the battery 845 or the elevator car 810 may have the alignment feature 935.

In some embodiments, the battery 845 may include a thermal management system, shown as heating system 940. The heating system 940 may be configured to keep a temperature of the battery 845 within a predetermined temperature range. The heating system 940 may use power from the battery 845 to operate. In some embodiments, the heating system 940 may be a continuous system configured to constantly operate to maintain a consistent temperature of the battery 845. In some embodiments, the heating system 940 may be a variable system configured to turn on and off to monitor and adjust the temperature of the battery 845. For example, the heating system 940 may include at least one sensor 945. The sensor 945 may be configured to detect the temperature of the battery 845. The heating system 940 may include a control system, shown as control 950. The control 950 may be configured to automatically operate the heating system 940 to maintain the temperature of the battery 845 within the predetermined temperature range based on the temperature detection made by the sensor 945. For example, the sensor 945 may detect a temperature that is below the predetermined temperature range. Responsive to detecting the low temperature, the control 950 may actuate the heating system 940 to increase the temperature until the sensor 945 detects a desired temperature (e.g., a temperature within the predetermined temperature range).

FIG. 10 is a flow diagram of a method 1000 to operate a lift system 805 of a wind turbine 800 with a portable battery 845, according to an example embodiment. Method 1000 includes disposing a battery 845 in a cabin 830 of an elevator car 810 (step 1005). The elevator car 810 is disposed in a wind turbine 800.

Method 1000 includes aligning a battery power terminal 925 with a lift power terminal 855 (step 1010). Aligning the battery power terminal 926 with the lift power terminal 855 may electrically couple the battery 845 with the traction hoist 835 of the lift system 805.

Method 1000 includes removably coupling the battery 845 with the elevator car 810 of the lift system 805 (step 1015). Step 1015 may include engaging a retention element 930 of the battery 845 with a retention feature 850 of the elevator car 810 to couple the battery 845 with the elevator car 810. The retention feature 850 may be disposed on a sidewall 820 of the elevator car 810 and the battery 845 may be coupled with the sidewall 820 of the elevator car 810.

Step 1015 may further include maintaining a temperature of the battery 845 within a predetermined temperature range via a heating system 940 of the battery 845. Maintaining the temperature may include detecting the temperature of the battery 845 via a sensor 945 and activating the heating system 940 via a control 950 of the heating system 940.

Method 1000 includes providing an input (step 1020). The input may be provided to the traction hoist 835 via a control panel 840 to cause the elevator car 810 to move within the wind turbine 800 based on power provided by the battery 845. For example, the input may include an operator pushing a button indicating to move the elevator car 810 in a desired direction (e.g., up or down). Step 1020 may include transmitting a signal to the traction hoist 835 via the control panel 840 from a remote location. The signal may be based on the input provided. Step 1020 may include actuating the traction hoist 835 based on the signal received to cause the elevator car 810 to move according to the input provided.

Method 1000 includes removing the battery 845 from the wind turbine 800 (step 1025). Step 1025 may include disconnecting the battery 845 from the elevator car 810. For example, the battery 845 may be disconnected with the car in a stored position. Step 1025 may include removing the battery 845 from the cabin 830 of the elevator car 810 such that the battery 845 can used in a different lift system 805 of a different wind turbine 800.

It will be appreciated that the foregoing description provides examples of the disclosed system. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range including the stated ends of the range, unless otherwise indicated herein, and each separate value is incorporated into the specification as if it were individually recited herein. All methods described herein can be performed in any suitable order unless otherwise indicated herein or otherwise clearly contradicted by context.

Although the disclosure has been described in detail, it should be understood that various changes, substitutions, and alterations could be made herein without departing from the spirit and scope of the invention as defined by the appended claims. Moreover, the scope of the present disclosure is not intended to be limited to the particular embodiments described in the specification. As one of ordinary skill in the art will readily appreciate from the disclosure of the present invention, processes, machines, manufacture, composition of matter, means, methods, or steps, presently existing or later to be developed that perform substantially the same function or achieve substantially the same result as the corresponding embodiments described herein may be utilized according to the present disclosure.

What is claimed is:

1. A lift system for a wind turbine, comprising:
an elevator car disposed inside the wind turbine, the elevator car comprising:
a platform to support a worker;
a sidewall extending from the platform; and
a top portion coupled with the sidewall, wherein the platform, the sidewall, and the top portion define a cabin;
a traction hoist coupled with the elevator car, the traction hoist configured to move the elevator car within the wind turbine;
a control panel operably coupled with the traction hoist, the control panel configured to receive an input to control the traction hoist; and
a portable battery configured to power the traction hoist, the portable battery configured to be coupled with the elevator car and electrically coupled with the traction hoist.

2. The lift system of claim 1, wherein the portable battery comprises a heating system, the heating system configured to use power from the portable battery to maintain a temperature of the portable battery within a predetermined temperature range.

3. The lift system of claim 2, wherein the heating system comprises:
a sensor configured to detect the temperature of the portable battery; and
a control system configured to automatically operate the heating system to maintain the temperature within the predetermined temperature range based on the detection made by the sensor.

4. The lift system of claim 1, further comprising:
a remote control panel disposed external to the elevator car;
an elevator control system disposed in the elevator car, the elevator control system configured to receive a signal from the remote control panel; and
a power supply configured to provide power to the elevator control system, the power supply separate from the portable battery.

5. The lift system of claim 1, wherein the portable battery comprises a length, a width, and a height, the width being less than the length and less than the height.

6. The lift system of claim 5, wherein the portable battery is configured to couple with the sidewall of the elevator car, wherein the portable battery extends into the cabin away from the sidewall a distance equal to the width of the portable battery.

7. The lift system of claim 1, further comprising:
a lift power terminal disposed on the sidewall of the elevator car, the lift power terminal electrically coupled with the traction hoist;
wherein the portable battery comprises a battery power terminal configured to align and electrically couple with the lift power terminal to electrically couple the portable battery with the traction hoist.

8. The lift system of claim 1, further comprising:
a retention feature disposed on the sidewall of the elevator car, the retention feature configured to secure the portable battery at a position within the elevator car and to maintain an electrical connection between the portable battery and the traction hoist.

9. The lift system of claim 8, wherein the portable battery comprises a retention element to engage with the retention feature of the elevator car to facilitate quick connection and disconnection from the sidewall of the elevator car.

10. The lift system of claim 9, wherein at least one of the portable battery or the elevator car comprise an alignment feature to facilitate proper placement and orientation of the portable battery to align a battery power terminal of the portable battery with a lift power terminal of the elevator car.

11. The lift system of claim 1, comprising no power supply cable extending between the traction hoist and a permanent power supply of the wind turbine.

12. The lift system of claim 1, wherein the traction hoist is configured to provide power to the portable battery via regenerative braking during a descent of the elevator car.

13. The lift system of claim 1, further comprising:
a supplemental battery electrically coupled with the traction hoist, the supplemental battery configured to provide less power than the portable battery, wherein the supplemental battery is configured to provide power to the hoist to facilitate a single trip for the elevator car; and
a trickle charge circuit connected to a turbine power supply, the supplemental battery configured to electrically couple with the trickle charge circuit with the elevator car in a stored position, the trickle charge circuit configured to charge the supplemental battery when the elevator car is in the stored position.

14. The lift system of claim 1, wherein the portable battery provides DC power to power the traction hoist, and wherein the traction hoist is configured to control an amount of the DC power consumed from the portable battery to gradually increase a speed of the elevator car.

15. A portable battery for a lift system of a wind turbine, comprising:
a body comprising a length, a width, and a height, wherein the width is less than the length and the height, and the body to be removably coupled with an elevator car of the lift system,
a battery power terminal disposed on the body, the battery power terminal configured to align with a lift power terminal of the lift system to electrically couple the portable battery with a traction hoist of the lift system; and
a retention element disposed on the body, the retention element configured to engage with a retention feature of the elevator car to removably couple the portable battery with the elevator car.

16. The portable battery of claim 15, further comprising:
a heating system that uses power from the portable battery to maintain a temperature of the portable battery within a predetermined temperature range.

17. The portable battery of claim 16, wherein the heating system comprises:
a sensor configured to detect the temperature of the portable battery; and
a control system configured to automatically operate the heating system to maintain the temperature within the predetermined temperature range based on the detection made by the sensor.

18. The portable battery of claim 15, wherein the retention feature of the elevator car is disposed on a sidewall of the elevator car such that the portable battery is configured to couple with the sidewall of the elevator car via engagement between the retention feature and the retention element.

19. A method to operate a lift system of a wind turbine with a portable battery, the method comprising:
removably coupling the portable battery with an elevator car, the elevator car disposed in the wind turbine;
aligning a battery power terminal with a lift power terminal to electrically couple the portable battery with a traction hoist of the lift system;
providing an input to the traction hoist via a control panel to cause the elevator car to move within the wind turbine based on power provided by the portable battery; and
removing the portable battery from the wind turbine.

20. The method of claim 19, further comprising:
engaging a retention element of the portable battery with a retention feature of the elevator car to couple the portable battery with the elevator car, wherein the retention feature is disposed on a sidewall of the elevator car and the portable battery is coupled with the sidewall of the elevator car.
